(19) United States
(12) Patent Application Publication
(10) Pub. No.: US 2002/0121725 A1
(43) Pub. Date: Sep. 5, 2002

(54) Process and device to form a bung and a fabrication mold for a hollow body, such as a tank, provided with a bung, equipped with such a device

(75) Inventor: Daniel Sobolewski, Bully Les Mines (FR)

Correspondence Address: John S. Egbert, Harrison & Egbert, 7th Floor, 412 Main Street, Houston, TX, 77002, US

(73) Assignee: NORMATEC Societe Anonyme, Bully Les Mines (FR)

(21) Appl. No.: 10/014,334

(22) Filed: Dec. 11, 2001

(30) Foreign Application Priority Data
Dec. 11, 2000 (FR) 00 16081

(51) Int. Cl. B29C 33/44; B29C 37/00

(52) U.S. Cl. 264/163; 425/290; 425/443; 425/DIG. 58; 264/318; 264/334

(57) ABSTRACT

The invention concerns a process and a device to form a bung in which a piece (1) is provided that features a protrusion (2) designed to define said bung, said protrusion (2) constituting a conduit (3) equipped with a previously closed first end, with said piece in place in an enclosure (5); said piece (1) is released from said enclosure (5) using relative driving means (6) of one in relation to the other and said previously closed end is unplugged using cutting means (7) operated, directly or not, by said driving means (6). The invention concerns also a fabrication mold for a hollow body, such as a tank, provided with a bung, equipped with the above-described device.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention concerns a process and a device to form a bung and a fabrication mold for a hollow body, such as a tank, provided with a bung, equipped with such device.

### BACKGROUND OF THE INVENTION

Currently, to manufacture tanks provided with a bung, a well-known method is to first form the tank, including through extrusion blow molding, while providing at its surface for a protrusion designed to define the bung, said protrusion constituting a conduit with a first previously closed end.

In order to define the bung, it is thus necessary to unplug said end. Depending on the applications intended for the tanks, it is also sometimes necessary that the bung be threaded.

According to the known processes, the thread is usually formed inside the mold. However, no device makes it possible to execute at the same time the threading and cutting of said end in the mold.

All these operations are thus costly in terms of time and machinery. Their multiplicity is also unfavorable to task automation and standardization.

### BRIEF SUMMARY OF THE INVENTION

The purpose of this invention is to propose a process and device to form a bung and a fabrication mold for a hollow body, such as a tank, provided with a bung, equipped with such device, that palliate the above-mentioned disadvantages and make it possible to reduce the rework operations necessary to make the bung.

Other goals and advantages of the invention will become apparent in the description to follow that is given for information only and is not intended to be limiting.

The invention concerns first a process to form a bung, in which a piece is provided with a protrusion designed to define said bung, said protrusion constituting a conduit provided with a first previously closed end, said piece being placed in an enclosure; said piece can be released from said enclosure using relative driving means of one in relation to the other and said previously closed end is unplugged using cutting means operated, directly or not, by said driving means.

The invention concerns also a bung-forming device, comprising an enclosure capable of accommodating a piece featuring a protrusion designed to define said bung, relative driving means of said piece in relation to said enclosure, capable of releasing said piece from said enclosure, and cutting means to unplug a previously closed end of a conduit made of said protrusion, operated by said driving means.

The invention also concerns a fabrication mold for a hollow body, such as a tank, provided with a bung, equipped with the above-described device.

### BRIEF DESCRIPTION OF THE SEVERAL VIEWS OF THE DRAWINGS

The invention will be better understood after reading the following description, together with the attached drawings in which:

FIGS. 1a through 1f schematically show the various steps of one implementation example of the process under the invention.

FIG. 2 shows in perspective an example of embodiment of the device under the invention.

FIG. 3a shows the embodiment example from FIG. 2 in radial section.

FIG. 3b shows an alternative implementation of the former.

FIG. 4 is a cross section along line IV-IV represented in FIG. 3a.

FIG. 5 is a top view according to FIG. 2.

FIG. 6 shows in perspective one of the components of the cutting means in FIG. 2 embodiment example.

### DETAILED DESCRIPTION OF THE INVENTION

The invention concerns first a bung forming process.

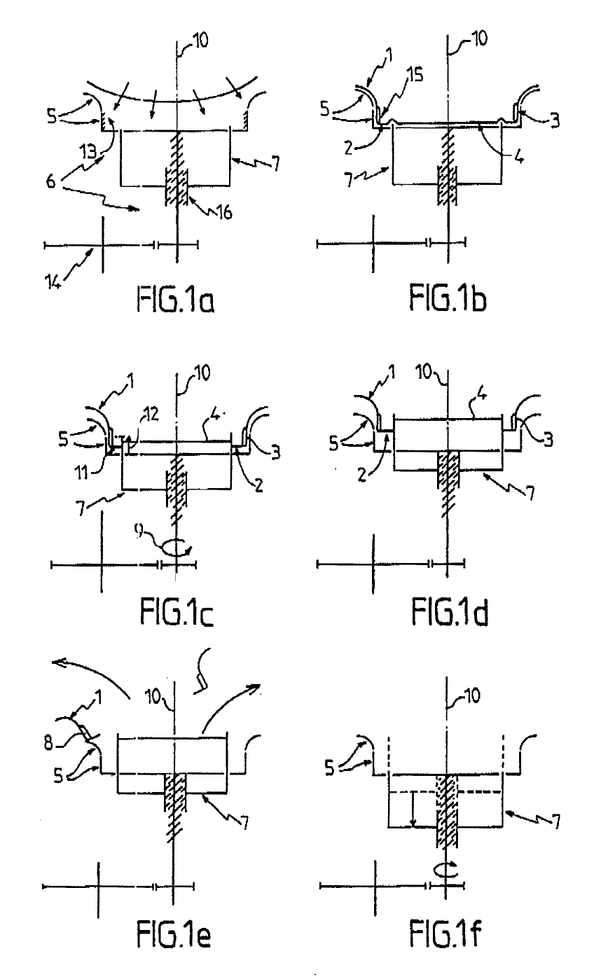

As shown on FIG. 1, and more specifically on FIG. 1b, according to the process under the invention, first a piece 1 is provided that features a protrusion 2 designed to define said bung, which protrusion 2 constitutes a conduit 3 provided with a first previously closed end 4, said piece being placed in an enclosure 5, partially represented.

To have said piece 1 available, it is of course necessary to remove it from the enclosure 5. To that effect, as shown in FIGS. 1c through 1e, its release is made possible using the relative driving means 6 of said piece 1 in relation to said enclosure 5 and under the invention, said previously closed end 4 is unplugged using the cutting means 7 operated, directly or not, by said driving means 6.

Thus the removal movement of piece 1 is used to simultaneously form bung 8 without rework.

Said piece 1 is achieved beforehand, for example, in said enclosure 5, including through the molding of a material designed to cover the walls of said piece over a specified thickness. The enclosure 5 is then used both to manufacture piece 1 and to form bung 8. Said piece 1 and said protrusion 2 are made for example from the block of each other, such as in enclosure 5. Thus the piece 1 and the protrusion 2 designed to constitute the bung are achieved simultaneously in the same tooling.

Said piece 1 is made, for example, of a hollow body, such as a tank or equivalent. Said enclosure 5 may be closed to that effect, with its dimensions corresponding to those of the piece 1 to be formed. The molding of this piece is done for example using blow extrusion.

Under a special embodiment of the invention, the driving means 6 are operated in rotation per the arrow marked 9 around the longitudinal axis 10 of said protrusion 2; the rotation of said driving means 6 is transformed into a separation movement, marked 11, in relation to said axis 10 of said piece 1 and of said enclosure 5 and the rotation of said driving means 6 is transformed into a penetration movement, marked 12, about said axis 10, of the cutting means 7 into said previously closed end 4. In order for this end to be unplugged prior to releasing piece 1, said penetration movement 12 is done faster than said separation movement 11, as shown more specifically in FIG. 1c.

Prior to releasing piece 1, threading can possibly be carried out at the surface of said conduit 3 using an imprint 13, defining part of said enclosure 5. Said thread is provided, for example, along the outside surface of the sidewalls making up said conduit. It is achieved, for example, when molding the piece 1 through solidification of the material at said imprint 13 that bears a negative of the threads.

The separation between said piece 1 and said enclosure 5 is then achieved by unscrewing said protrusion 2. Thus one piece 1 provided with a threaded bung 8 can be achieved in one single tooling, without reworking operation.

As an example, the successive steps taken are the following:

the piece 1 and protrusion 2 are molded through blow extrusion from the block of each other in enclosure 5 provided with its imprint 13, as shown in FIG. 1a.

with the piece 1 provided with its protrusion 2 in place in the enclosure 5, as shown in FIG. 1b, the driving means 6 are operated to release piece 1 by unscrewing it, with the cutting means 7 moving parallel to axis 10 under the action of said driving means 6 faster than the separation movement 11 resulting from the unscrewing, as shown in FIG. 1c.

once the piece 1 is released and the previously closed end 4 is cut, said piece 1 provided with its threaded bung 8 is removed from enclosure 5, as shown on FIGS. 1d and 1e.

then, the cutting means are returned to their original position before starting a new cycle, as shown in FIG. 1f.

In place and/or in addition to threads, an insert can also be provided at the bung, duplicate molded, provided with imprints allowing for bayonet type catch attachment.

The invention concerns also a bung-forming device, especially for the implementation of the above-described process. It comprises an enclosure 5 capable of accommodating a piece 1 featuring a protrusion 2 designed to define said bung, relative driving means 6 of said piece 1 in relation to said enclosure 5, capable of releasing said piece 1 from said enclosure 5, and cutting means 7 to unplug a previously closed end 4 of a conduit 3 made of said protrusion 2, operated by said driving means 6.

Said device includes, for example, means 14 to operate said driving means 6 in rotation around an axis 10, so-called pivot axis, designed to correspond to the longitudinal axis of said protrusion 2 whenever the piece 1 is in place in said enclosure 5, first means 15 to transform the rotation of said driving means 6 into a separation movement along said pivot avis 10 of said piece 1 in said enclosure 5, and second means 16 to transform the rotation of said driving means 6 into a penetration movement along said pivot axis 10, cutting means 7 in said previously closed end 4. The second means are capable of causing a penetration movement that is faster than the separation movement caused by the first means 15.

Said device can also include, for example, means to make threads at the surface of said conduit 3. They may consist of an imprint 13 defining part of said enclosure 5. The first means 15 to transform the rotation of said driving means 6 into a separation movement 11 consist then of the threading made at the surface of said piece 1 to be rotated by said driving means 6.

As mentioned above, the release of piece 1 is then achieved by unscrewing said protrusion 2 off said imprint 13.

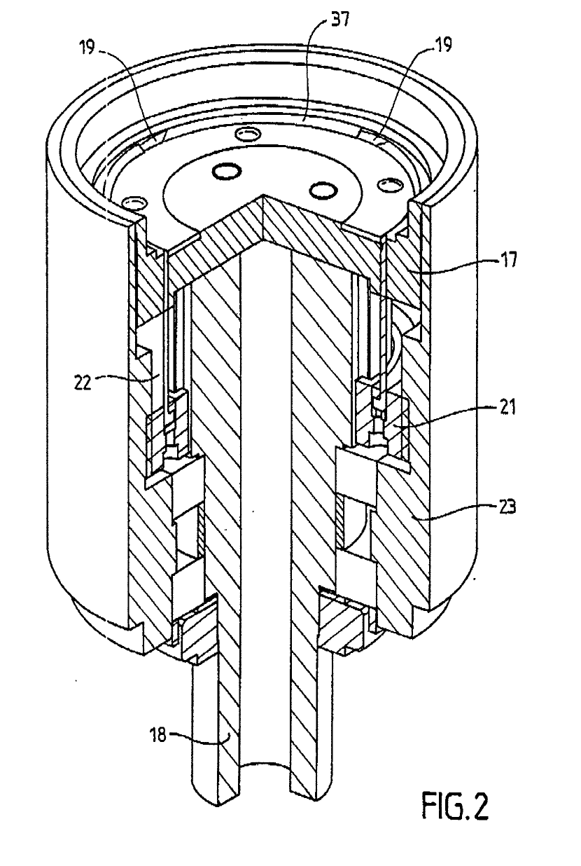

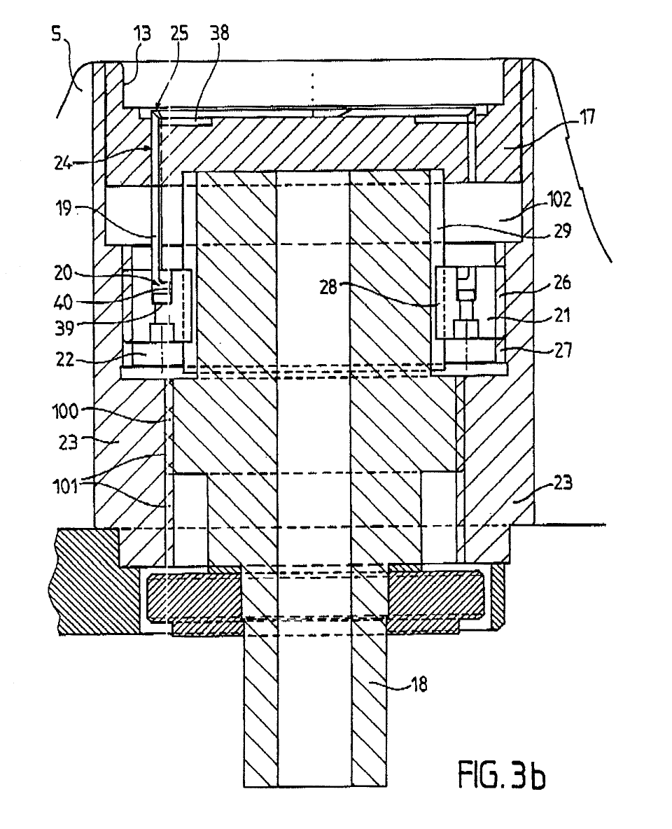

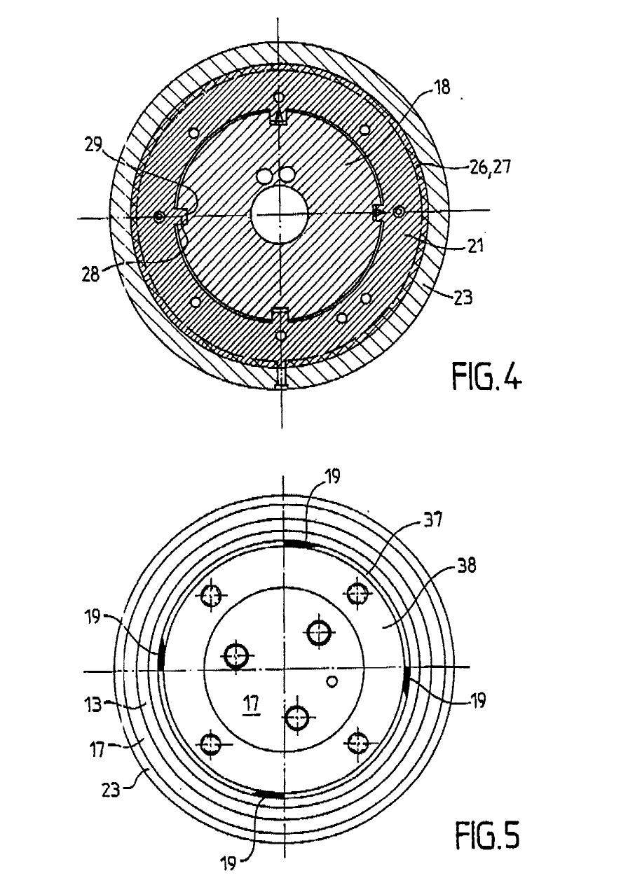

As shown in FIG. 2 through 5, said driving means 6 consist, for example, of a component 17 bearing said imprint 13 and of a rotating central core 18 capable of operating said component 17 bearing the imprint around said pivot axis 10.

Said central core can, for example, be driven at least in rotation around its longitudinal axis to correspond to said longitudinal axis 10 by said means to operate the driving means not represented on these figures.

Said cutting means 7 can consist, for example, of one or more blades 19, said blade(s) 19 resting through one end 20 on a nut 21 driven under the action of said central core 18 in either direction along said pivot axis 10 inside a reservation 22 provided between said central core 18 and a fixed sleeve 23 coaxial to said central core 18. Said blade(s) 19 emerge via a hole 24 through said component 17 bearing the imprint at their so-called cutting end 25 opposite to end 20 resting on said nut 21.

Said nut features, for example, an inside thread 26, cooperating with an inside tap 27 provided on said sleeve 23 at said reservation 22. In order to be driven by said central core 18, said nut 21 also features at least one rib and/or cotter 28, for example four, cooperating with as many notches 29 with radial orientation provided in said central core 18. Under such embodiment, the direction of the thread helix 27 is reverse to the direction of thread helix 13.

In that regard, said nut 21 and said imprint 13 have a differential pitch allowing for a movement of end 25 of blades 19 that is faster than the unscrewing of protrusion 2 in component 17 bearing said imprint 13. The nut pitch 21 depends on the pitch of thread 13 and on the thickness of the material of said previously closed end 4.

Under the above-described embodiment, blades 19 are subject to a translation movement in relation to said component 17 bearing imprint 13 and to a screw rotation movement in relation to said protrusion 2, based on the thread differential pitch.

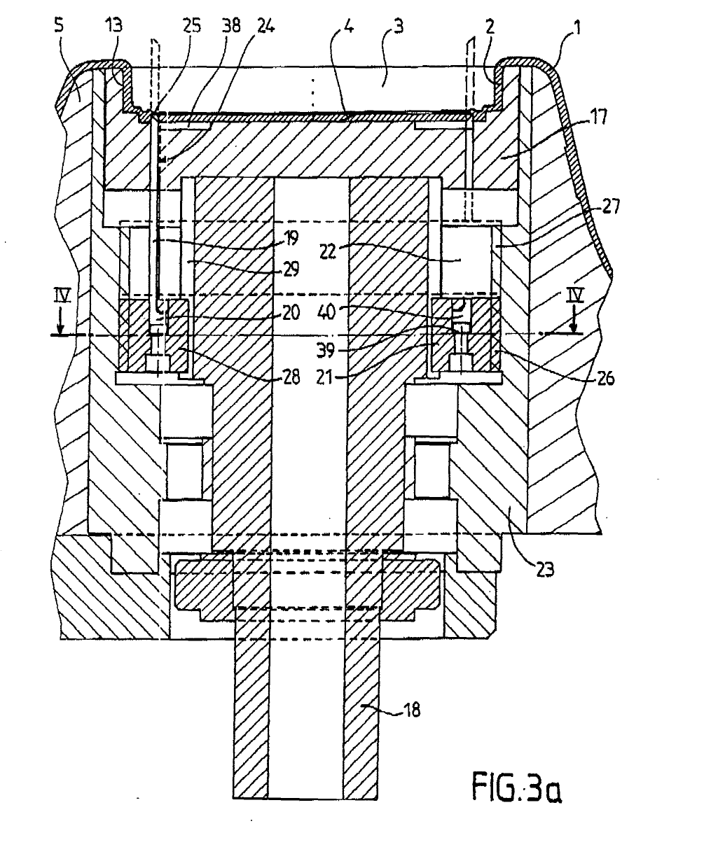

Under a first embodiment shown in FIG. 3a, said core 18 is driven solely in rotation, thus causing the unscrewing of component 17 without return movement of component 17.

Under a second embodiment, shown in FIG. 3b, said core 18 is also mobile in translation along its longitudinal axis 10 in relation to sleeve 23, said core 18 and said sleeve 23 featuring to that effect, for example, a thread 100 or a tap 101 cooperating with each other.

Said component 17, attached to said core 18, moves in a cavity 102 provided in sleeve 23. The direction of thread 101 helix of the sleeve cooperating with each other with thread 100 of core 18 is identical to the direction of the thread helix of imprint 13. Other characteristics of the device are, for example, identical to those of the embodiment in FIG. 3a, with an unscrewing action with return movement of component 17 that may be useful in some specific molds, as further addressed below.

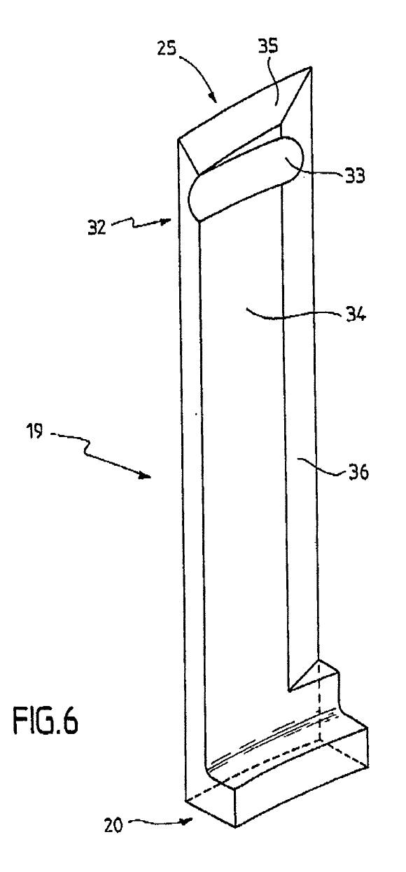

As shown in FIG. 6, said blades 19 can also contain means 32 to hold said previously closed end 4 after cutting. They may consist of a slot 33 provided crosswise in the thickness of said blades at their face 34 designed to be opposite said previously closed end 4 when cutting.

Referring again to FIGS. 2, 4 and 5, it is noted that the device under the invention can also contain means to initiate a cut into the thickness of said previously closed end 4. They consist of:

means to position in a protruding manner said blades 19 in relation to hole 24 through which they emerge.

a rib 37 extending in a circular manner around said pivot axis 10 the protruding part of said blades 19 at the surface of said component 17 bearing the imprint.

Said rib 37 may be provided at the level of a washer 38 lodged in said component 17 bearing the imprint. Like the cutting end 25 of blades 19, it features a sharp edge designed to penetrate into the material of the previously closed end 4 of the protrusion 2.

Said positioning means may consist of means allowing to adjust the position of the ends 20 of blades 19 resting on said nut 21 in relation to the bottom 39 of a groove 40 provided therein. Before cutting, the blades 19 can thus be flush with hole 24 trough which they emerge from said component 17 bearing the imprint at the same height as rib 37, regardless of the angular position of the central core 18, which makes it possible to use this characteristic with thread indexing.

There can for example be four blades 19, all parallel to said pivot axis 10 and located at the same distance from said axis. When increasing the number of blades, the thickness of the cuts to be made by each one of them is reduced.

Said blades 19 may have an active angle 35, 36 as already mentioned, at their cutting end 25 and/or at their lateral edge designed to penetrate into the material of said previously closed end 4 when said blades 19 move.

Means to blow air into said piece 1 can be provided in the vicinity of said pivot axis 10, based on the eccentricity of the cutting means 7 and of their activating component.

Said washer 38 can possibly be made of a material that is less heat-conducting than that of component 17 bearing the imprint 13 so as to slow down the setting of the material of piece 1 in the vicinity of the cut to be made.

Thread indexing can be done with an arc and pinion system.

The invention also concerns a fabrication mold for a hollow body, such as a tank, provided with a bung, equipped with the above-described device.

It contains a mold cavity defined by said enclosure 5. It is capable of permitting the making of said protrusion 2 and said piece 1, for example, from the block of each other, by blowing a material designed to cover the walls of said enclosure 5 to a specified thickness.

This can, for example, be a blow extrusion mold in which the above-mentioned device is integrated at the location designed to allow for formation of the protrusion 2.

Said mold consists for example of a first and second imprints defining between them said mold cavity.

According to a first embodiment, axis 10 of said conduit 3 is roughly parallel to the opening direction of said first and second imprints. The bung forming device according to the invention can then be equipped with a central core 18, fixed in relation to said first or second imprint in which it is to be located, as in the case shown in FIG. 3a.

According to a second embodiment, axis 10 of said conduit 3 is concurrent with the opening direction of said first and second imprints. The bung forming device according to the invention can then be equipped with a central core 18 mobile along said axis of conduit 3 in relation to said first or second imprint in which it is to be located, as in the case shown in FIG. 3b.

Of course, other implementations within the reach of the man skilled in the art could have been considered without being out of the scope of the invention.

I claim:

1. Bung forming process in which a piece (1) is provided, featuring a protrusion (2) designed to define said bung, said protrusion (2) constituting a conduit (3) with a previously closed end (4), with said piece (1) in place in enclosure (5); the release of said piece (1) from said enclosure (5) is permitted using relative driving means (6) of one (1) in relation to the other (5) and in which said previously closed end (4) is unplugged using cutting means (7) operated, directly or not, by said driving means (6).

2. Process according to claim 1, in which said driving means (6) are operated in rotation around the longitudinal axis (10) of said protrusion (2); the rotation of said driving means (6) is transformed into a separation movement (11) along said axis (10) of said piece (1) and said enclosure (5) and the rotation of said driving means (6) is transformed into a penetration movement (12) along said axis (10) of the cutting means (7) into said previously closed end (4), with said penetration movement (12) being faster than said separation movement (11).

3. Process according to claim 2 in which, prior to releasing piece (1), a thread is made at the surface of said conduit using an imprint (13) defining part of said enclosure (5) and the rotation of said driving means (6) is transformed into a separation movement of said piece (1) and of said enclosure (5) by unscrewing said protrusion (2).

4. Device to form a bung, comprising an enclosure (5) capable of accommodating a piece (1) featuring a protrusion (2) designed to define said bung, relative driving means (6) of said piece (1) in relation to said enclosure (5), capable of permitting the release of said piece (1) from said enclosure (5) and cutting means (7) to unplug a previously closed end (4) of a conduit (3) consisting of said protrusion (2), operated by said driving means (6).

5. Device according to claim 4, comprising means (14) to operate said driving means (6) in rotation around a so-called pivot axis (10), designed to correspond to the longitudinal axis of said protrusion (2) whenever the piece (1) is in place inside said enclosure (5), first means (15) to transform the rotation of said driving means (6) into a separation movement (11), about said pivot axis (10), of said piece (1) and said enclosure (5), and second means (16) to transform the rotation of said driving means (6) into a penetration movement (12), about said pivot axis (10), of the cutting means (7) into said previously closed end (4), with said seconds means (16) capable of causing a penetration movement (12) faster than the separation movement (11) caused by said first means (15).

6. Device according to claim 5, comprising means to make a thread at the surface of said conduit (3) consisting of an imprint (13) defining part of said enclosure (5) and in which said first means (15) to transform the rotation of said driving means (6) consist of the thread made at the surface of said piece (1) to be operated in rotation by said driving means (6).

7. Device according to claim 6 in which said driving means (6) consist of a component (17) bearing said imprint (13) and of a rotating central core (18), capable of operating said component (17) bearing the imprint around said pivot axis (10).

8. Device according to claim 7 in which said cutting means (7) consist of one or more blades (19), with said blade(s) (19) resting at one end (20) on a nut (21), driven under the action of the central core (18) in either direction about said pivot axis (10) inside a reservation (22) provided between said central core (18) and a fixed sleeve (23), coaxial to said central core (18), with said blade(s) (19) emerging via a hole (24) through said component (17) bearing the imprint with their end (25) opposite to that (20) resting on said nut (21).

9. Device according to claim 8, in which said nut (21) and said imprint (13) have a differential pitch allowing for a movement of the blade (19) end that is faster than the unscrewing of the protrusion (2) in the component (17) bearing the imprint (13).

10. Device according to claim 8, in which said blades (19) comprise means (32) to hold said previously closed end (4) after being cut.

11. Device according to claim 10, in which said means (32) to hold said previously closed end (4) consist of a slot (33) provided crosswise in the thickness of said blades (19) at the level of their face (34) designed to be opposite to said previously closed end (4) when cutting.

12. Device according to claim 8, comprising means to initiate a cut in the thickness of said previously closed end (4).

13. Device according to claim 12, in which said means to initiate a cut consist of:
means to position in a protruding manner said blades (19) in relation to hole (24) from which they emerge, before cutting.
a rib (37) extending in a circular manner around said pivot axis (10) the protruding part of said blades (19) at the surface of said component (17) bearing the imprint.

14. Device according to claim 13, in which said positioning means consist of means permitting to adjust the position of the ends (20) of the blades resting on said nut (21) in relation to the bottom (39) of a groove (40) provided therein.

15. Fabrication mold for a hollow body, such as a tank, provided with a bung, equipped with the device according to any of claims 8 through 14.

16. Mold according to claim 15, consisting of a first and second imprints defining between them a mold cavity of said hollow bodies, with said first and second imprints being capable of separating from each other along a direction roughly parallel to the longitudinal axis of said conduit (3), said mold being equipped with a central core (18) fixed in relation to said first or second imprint in which said device is to be located.

17. Mold according to claim 15, consisting of a first and second imprints defining between them a mold cavity of said hollow bodies, with said first and second imprints being capable of separating from each other along a direction concurrent to the longitudinal axis of said conduit (3), said mold being equipped with a central core (18) mobile along said longitudinal axis of the conduit (3) in relation to said first or second imprint in which said device is to be located.
